(19) United States
(12) Patent Application Publication
(10) Pub. No.: US 2005/0266175 A1
(43) Pub. Date: Dec. 1, 2005

(54) Retardation coating

(76) Inventors: Yong Hsu, Woodbury, MN (US); Richard J. Pokorny, Maplewood, MN (US); Steven D. Solomonson, Shoreview, MN (US); Marc D. Radcliffe, Newport, MN (US); Yifan Zhang, Woodbury, MN (US)

Correspondence Address: 3M INNOVATIVE PROPERTIES COMPANY, PO BOX 33427, ST. PAUL, MN, 55133-3427, US

(21) Appl. No.: 10/855,662

(22) Filed: May 27, 2004

(51) Int. Cl. G02F 1/13; C09K 19/52

(52) U.S. Cl. 428/1.1; 252/299.01

(57) ABSTRACT

An optical body includes an optical element, an alignment layer disposed on the optical element, and a liquid crystal layer disposed on the alignment layer. The liquid crystal layer has a retardation (R) at all wavelengths (λ) from 400 nm to 700 nm equal to a formula R=λ/4±20 nm. The liquid crystal layer can include from 85 to 99 phr of an achiral liquid crystal material, from 1 to 15 phr of a chiral nematic liquid crystal material, and a surfactant.

### BACKGROUND

This invention relates to optical retardation means such as retarder films coated on optical bodies. Specifically, the invention relates to thin film retarders that have improved retardation achromaticity throughout the visible spectrum.

Optical devices, such as retarder films, are useful in a variety of applications including liquid crystal displays (LCD's). Liquid crystal displays fall broadly into two categories: backlit (e.g., transmissive) displays, where light is provided from behind the display panel, and frontlit (e.g., reflective) displays, where light is provided from the front of the display (e.g., ambient light). These two display modes can be combined to form transflective displays that can be backlit, for example, under dim light conditions or read under bright ambient light.

Retardation films are used in liquid crystal displays and the like, and they are employed to solve such problems as color compensation and to achieve viewing angle widening. The materials generally used in retardation films for color compensation are polycarbonates, polyvinyl alcohol, polysulfone, polyethersulfone, amorphous polyolefins and the like, while the materials used in retardation films for viewing angle widening are those mentioned above, as well as polymer liquid crystals, discotic liquid crystals, and the like.

A quarter-wave plate, which is one type of retardation film, can convert circularly polarized light to linearly polarized light, or linearly polarized light to circularly polarized light. This has been utilized in liquid crystal display devices and, particularly, in reflective liquid crystal display devices having a single polarizing plate where the rear electrode, as viewed by an observer, is the reflecting electrode, in anti-reflection films comprising a combination of a polarizing plate and a quarter-wave plate, or in combination with reflective polarizing plates composed of cholesteric liquid crystals or the like that reflect only circularly polarized light only in either the clockwise direction or counter-clockwise direction.

The retardation films used in the aforementioned single polarizing plate-type reflective liquid crystal display devices and reflective polarizing plates have a function of converting linearly polarized light to circularly polarized light and circularly polarized light to linearly polarized light, in the visible light region with a wavelength range of 400-700 nm. When this is accomplished with a single retardation film, the retardation film ideally has an achromatic retardation of λ/4 over a wavelength λ range of 400-700 nm.

Although the aforementioned color compensating retardation film materials are commonly used as quarter-wave plates, these materials exhibit birefringent wavelength dispersion. The birefringence of most polymer films becomes larger as the wavelength becomes shorter, and becomes smaller at longer wavelengths. Consequently, with a single polymer film it is difficult to achieve a smaller birefringence at shorter wavelengths over a wavelength range of λ=400-700 nm, such as with the aforementioned ideal achromatic quarter-wave plate.

Current techniques require the use of multiple films or a single thick film in order to achieve a smaller retardation with shorter wavelengths as with ideal quarter-wave plates, and this has presented problems such as additional steps for film attachment and increased costs as well as greater expense for the optical design. In addition, current retardation films only provide achromaticity over a narrow wavelength range.

### SUMMARY

Generally, the present invention relates to coated retarder films, their manufacture, and their use on optical bodies or devices, such as optical films. Improved achromatic retarder films, methods and apparatus for forming the improved achromatic retarder films are described.

In an illustrative embodiment, an optical body includes an optical element, an alignment layer disposed on the optical element, and a liquid crystal layer disposed on the alignment layer. The liquid crystal layer has a retardation (R) at all wavelengths (λ) from 400 nm to 700 nm equal to a formula R=λ/4±20 nm. The liquid crystal layer can include from 85 to 99 phr of an achiral liquid crystal material, from 1 to 15 phr of a chiral nematic liquid crystal material, and a surfactant.

In another illustrative embodiment, a method of forming an optical body includes the steps of applying an alignment layer on an optical element and coating a flowable liquid crystal material on the alignment layer. The liquid crystal material includes 85 to 99 phr of an achiral liquid crystal material, 1 to 15 phr of a chiral nematic liquid crystal composition, 0.1 to 30 phr of a surfactant, and a solvent. Then, removing the solvent from the liquid crystal material to form a liquid crystal layer.

The liquid crystal layer can be cured to “fix” the liquid crystal layer. U.V. light or radiation can be used to cure the liquid crystal layer.

The above summary of the present invention is not intended to describe each disclosed embodiment or every implementation of the present invention. The Figures, Detailed Description and Examples which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a sectional view of an optical body according to an embodiment of the invention;

FIG. 2 is a schematic view of a process for coating a retardation film onto a substrate according to an embodiment of the invention;

FIG. 3 is a graph of measured retardation values for Examples 1-4; and

FIG. 4 is a graph of measured retardation values of two commercially available retardation films and a retardation film according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention is believed to be applicable to optical bodies (such as optical films) and their manufacture, as well as the use of the optical bodies in optical devices, such as optical displays (e.g., liquid crystal displays). While the present invention is not so limited, an appreciation of various aspects of the invention will be gained through a discussion of the examples provided below.

For the following defined terms, these definitions shall be applied, unless a different definition is given in the claims or elsewhere in this specification.

The term “polymer” will be understood to include polymers, copolymers (e.g., polymers formed using two or more different monomers), oligomers and combinations thereof, as well as polymers, oligomers, or copolymers that can be formed in a miscible blend by, for example, coextrusion or reaction, including transesterification. Both block and random copolymers are included, unless indicated otherwise.

The term “polymeric material” will be understood to include polymers, as defined above, and other organic or inorganic additives, such as, for example, antioxidants, stabilizers, antiozonants, plasticizers, dyes, and pigments.

The term a “nematic” liquid crystal compound refers to a liquid crystal compound that forms a nematic liquid crystal phase.

The term a “chiral” unit refers to an asymmetrical unit that does not posses a mirror plane. A chiral unit is capable of rotating a plane of polarized light to either the left or the right in a circular direction.

The term “phr” refers to a unit of parts by weight of a component in a coating composition having 100 parts by weight of liquid crystal composition.

The term a “mesogenic” unit refers to a unit having a molecular structure that facilitates the formation of a liquid crystal mesophase.

The term “solvent” refers to a substance that is capable of at least partially dissolving another substance (solute) to form a solution or dispersion. A “solvent” may be a mixture of one or more substances.

The term “chiral material” refers to chiral compounds or compositions, including chiral liquid crystal compounds and chiral non-liquid crystal compounds that can form or induce a chiral nematic liquid crystal mesophase in combination with other liquid crystal material.

The term “achiral material” refers to achiral compounds or compositions.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

An achromatic optical film can be formed on an optical element by coating a liquid crystal material on an alignment layer disposed on the optical element. The liquid crystal material can include a chiral nematic material, an achiral material and a surfactant. The chiral nematic material can include a chiral nematic liquid crystal. The achiral material can include an achiral liquid crystal. The liquid crystal material can optionally include a plasticizer.

In one embodiment, an optical body includes a substrate having an alignment layer disposed on the substrate. The substrate could be an optical element, as desired. A liquid crystal layer can be coated on the alignment layer. The liquid crystal coating or layer can include 85 to 99 phr of an achiral liquid crystal material, 1 to 15 phr of a chiral nematic liquid crystal material, and 0.1 to 30 phr of a surfactant. The liquid crystal coating can be a flowable composition that can include a solvent. The solvent can be removed after the flowable composition is coated onto the substrate to form a liquid crystal layer. The liquid crystal layer can be cured with U.V. light or radiation, as desired. In this illustrative embodiment, the liquid crystal layer can have a retardation (R) at all wavelengths (λ) from 400 nm to 700 nm equal to a formula R=λ/4±20 nm.

Liquid crystal compositions can be formed into a layer that can change the phase of polarized light and form, for example, a quarter wave plate or half wave plate. A quarter wave plate or half wave plate are also known as retarder films.

Retardation of a film is the difference in phase when light passes through a birefringent material, based on the difference in the speed of light (refractive index) in the orientation direction of the film and the direction perpendicular thereto. Retardation is known to be represented by:
R=Δn·d
as the product of the difference in refractive indexes in the orientation direction and the direction perpendicular thereto “Δn” and the film thickness “d”.

The retarder coating can have a retardation substantially a quarter of the wavelength of the light incident on the retarder coating when measured at wavelengths from 400-700 nm. A quarter wave plate has a ratio of (Δn·d)/λ, where λ is the incident light, in the range of 0.2 to 0.3, or 0.25.

Liquid crystal retarder films can be formed by coating at least one achiral liquid crystal material, at least one chiral nematic liquid crystal material, and a surfactant on a substrate. The surface of the substrate (e.g., the surface of an alignment layer provided as part of the substrate) has a surface alignment feature that can improve or provide uniformity of alignment of the chiral nematic liquid crystal material disposed thereon. A surface alignment includes any surface features that produce alignment of the director of the liquid crystal material at that surface. Surface alignment features can be produced by one or more different methods including, for example, mechanical or physical alignment, or chemical and photoalignment techniques.

The substrate can provide a base for deposition or formation of an optical body or structure including the various liquid crystal compounds. The substrate can be a structural support member during manufacture, use or both. The substrate can be an optical element such as, for example, a polarizer or a liquid crystal cell. The substrate may be transparent over the wavelength range of operation of the optical body. Examples of substrates include cellulose triacetate (TAC, available from, for, example, Fuji Photo Film Co., Tokyo, Japan; Konica Corporation, Toyko, Japan; and Eastman Kodak Co., Rochester, N.Y.), Sollx™ (available from General Electric Plastics, Pittsfield, Mass.), and polyesters, such as polyethylene terphathalate (PET), and the like. In some embodiments, the substrate is non-birefringent.

The liquid crystal layer of the invention includes a relatively large amount of achiral liquid crystal material and a relatively small amount of chiral nematic liquid crystal material. The liquid crystal layer can be described as twisted nematic based on the particular selection of liquid crystal materials. In an illustrative embodiment, the liquid crystal layer includes from 85 to 99 phr of an achiral liquid crystal material and from 1 to 15 phr of a chiral nematic liquid crystal material.

Chiral nematic liquid crystal material generally includes molecular units that are chiral in nature (e.g., molecules that do not possess a mirror plane) and molecular units that are mesogenic in nature (e.g., molecules that exhibit liquid crystal phases) and can be polymers. Chiral nematic liquid crystal material includes compounds having a twisted nematic liquid crystal phase in which the director (the unit vector that specifies the direction of average local molecular alignment) of the liquid crystal rotates in a helical fashion along the dimension perpendicular to the director. The pitch of the chiral nematic liquid crystal material is the distance (in a direction perpendicular to the director and along the axis of the chiral nematic helix) that it takes for the director to rotate through 360°.

The pitch of a chiral nematic liquid crystal material can also be induced by mixing or otherwise combining (e.g., by copolymerization) a chiral nematic material with a nematic or achiral liquid crystal material. The pitch may depend on the relative ratios by weight of the chiral nematic material and the nematic liquid crystal material. The helical twist of the director results in a spatially periodic variation in the dielectric tensor of the material, which in turn gives rise to the wavelength selective reflection of light. In some embodiments, the pitch of the liquid crystal material is less than a thickness of the liquid crystal layer.

Chiral and achiral liquid crystal materials, including chiral nematic and achiral liquid crystal polymers, are generally known and typically any of these materials can be used to make optical bodies. Examples of suitable liquid crystal polymers are described in U.S. Pat. Nos. 4,293,435 and 5,332,522, 5,886,242, 5,847,068, 5,780,629, 5,744,057 and EP 1 363 144 A1, all of which are incorporated herein by reference. Other liquid crystal material can also be used. A liquid crystal material may be selected for a particular application or optical body based on one or more factors including, for example, refractive indices, surface energy, pitch, processability, clarity, color, low absorption in the wavelength of interest, compatibility with other components (e.g., a plasticizer), molecular weight, ease of manufacture, availability of the liquid crystal compound or monomers to form a liquid crystal polymer, rheology, method and requirements of curing, ease of solvent removal, physical and chemical properties (for example, flexibility, tensile strength, solvent resistance, scratch resistance, and phase transition temperature), and ease of purification.

Liquid crystal polymers are generally formed using achiral or chiral (or a mixture of chiral and achiral) molecules (including monomers) that can include a mesogenic group (e.g., a rigid group that typically has a rod-like structure to facilitate formation of a twisted nematic liquid crystal phase). Mesogenic groups include, for example, para-substituted cyclic groups (e.g., para-substituted benzene rings). The mesogenic groups are optionally bonded to a polymer backbone through a spacer. The spacer can contain functional groups having, for example, benzene, pyridine, pyrimidine, alkyne, ester, alkylene, alkene, ether, thioether, thioester, and amide functionalities. The length or type of spacer can be altered to provide different properties such as, for example, solubilities in solvent(s).

Suitable liquid crystal polymers include polymers having a chiral or achiral polyester, polycarbonate, polyamide, polyacrylate, polymethacrylate, polysiloxane, or polyesterimide backbone that include mesogenic groups optionally separated by rigid or flexible comonomers. Other suitable liquid crystal polymers have a polymer backbone (for example, a polyacrylate, polymethacrylate, polysiloxane, polyolefin, or polymalonate backbone) with chiral and achiral mesogenic side-chain groups. The side-chain groups are optionally separated from the backbone by a spacer, such as, for example, an alkylene or alkylene oxide spacer, to provide flexibility.

A surfactant is included in the liquid crystal layer. While not wishing to be bound by any particular theory, it is believed that the surfactant acts to enhance alignment of the liquid crystal layer with the alignment layer. In one embodiment the surfactant can be present in the liquid crystal layer from 0.1 to 30 phr, or 1 to 20 phr. In an illustrative embodiment, if a fluorinated surfactant is present in the liquid crystal layer the fluorinated surfactant can be provided from 0.1 to 5 phr, or 0.1 to 3 phr, or 0.1 to 2 phr.

The surfactant can be chosen from among known surfactants, such as alcohols, amines or other amphiphilic molecules, or salts. Single or multiple surfactants can be employed to facilitate formation of the retarder coating. One useful surfactant is one drawn from the class of fluorocarbons. The term “fluorocarbon” includes perfluorocarbon compounds. A partial listing of fluorocarbon surfactants can be found in EP 1 156 349 A1, which in incorportated by reference herein.

Fluorinated surfactants can include a fluorine-containing hydrophobic group, a non-ionic, anionic, cationic, or amphoteric hydrophilic group, and an optional linking group. A fluorinated surfactant can have the structure R₁EX, where R₁ is a fluorinated alkyl or a fluorinated polyether group with a carbon number between 4 and 16, E is an alkylene group with a carbon number between 0 and 4, and X is an anionic salt such as COOM, SO₃ M, SO₄ M, a cationic moiety such as quaternary ammonium salt, or an amphoteric moiety such as amineoxide, or a non-ionic moiety such as (CH₂CH₂O)ₙ H and its derivatives; and M is H, Li, Na, K, or NH₄; and n is a cardinal number of 2 to 40. Commercially available fluorinated surfactants include, for example, Novec FC-4430 series, and FC-4432 series (3M, St. Paul, Minn.)

Fluorinated hydrocarbon surfactants or processing aids can be a fluorinated and/or perfluorinated saturated aliphatic compounds such as a fluorinated or perfluorinated alkanes. Fluorinated or perfluorinated alkanes can be linear or branched, having between 3 to 20 carbon atoms. Oxygen, nitrogen or sulfur atoms can also be present in the molecules. It can also be a fluorinated aromatic compound such as fluorinated benzene; a fluorinated alkyl amine such as a fluorinated trialkyl amine; a fluorinated cyclic aliphatic, such as decalin or fluoro tetradecahydrophenanthrene; or a heterocyclic aliphatic compound containing oxygen or sulfur in the ring, such as fluoro-2-butyl tetrahydrofuran. Examples of perfluorinated hydrocarbons include perfluoro-2-butyltetrahydrofuran, perfluorodecalin, perfluoromethyidecalin, perfluorodimethyldecalin, perfluoromethylcyclohex-ane, perfluoro(1,3-dimethylcyclohexane), perfluorodimethyldecahydronaphtha-lene, perfluorofluoorene, perfluorotetracosane, perfluorokerosenes, octafluoronaphthalene, oligomers of poly(chlorotrifluoroethylene), perfluoro(trialkylamine) such as perfluoro(tripropylamine), perfluoro(tributylamine), or perfluoro(tripentylamine), and octafluorotoluene, hexafluorobenzene, perfluoro ethers or perfluorinated polyethers, and commercial fluorinated solvents, such as Fluorinert FC-77 or FC-75 produced by 3M (St. Paul, Minn.), Zonyl series, Forafac series (Du Pont, Del.)

The substrate can have more than one layer. In one embodiment, the substrate contains an alignment layer having a surface capable of orienting a liquid crystal composition disposed on the alignment layer in a fairly uniform direction. Alignment layers can be made using one or more mechanical or chemical methods.

One mechanical method of making an alignment layer includes rubbing a polymer layer (e.g., poly(vinyl alcohol) or polyimide) in the desired alignment direction. Another physical method includes stretching or otherwise orienting a polymer film, such as a poly(vinyl alcohol) film, in the alignment direction. Any number of oriented polymer films exhibit alignment characteristics for LC materials, including polyolefins (such as polypropylenes), polyesters (such as polyethylene terephthalate and polyethylene naphthalate), polystyrenes (such as atactic-, isotactic-, or syndiotactic-polystyrene), cyclolefins,(norborene derivatives) available as Topaz series (Degussa, Del.), Arton, series (JSR, JP) Zeonor and Zenox series (Zeon, JP), and the like. The polymer can be a homopolymer or a copolymer and can be a mixture of two or more polymers. The polymer film acting as an alignment layer can include one or more layers. Optionally, the oriented polymer film acting as an alignment layer can include a continuous phase and a dispersed phase. Yet another physical method includes obliquely sputtering a material, such as SiOₓ, TiO₂, MgF₂, ZnO₂, Au, and Al, onto a surface in the alignment direction. Another mechanical method involves the use of microgrooved surfaces, such as that described in U.S. Pat. Nos. 4,521,080, 5,946,064, and 6,153,272, all of which are incorporated herein by reference.

An alignment layer can also be formed photochemically. Photo-orientable polymers can be formed into alignment layers by irradiation of anisotropically absorbing molecules disposed in a medium or on a substrate with light (e.g., ultraviolet light) that is linearly polarized in the desired alignment direction (or in some instances perpendicular to the desired alignment direction,) as described, for example, in U.S. Pat. Nos. 4,974,941, 5,032,009, and 5,958,293, all of which are incorporated by reference. Suitable photo-orientable polymers include polyimides, for example polyimides comprising substituted 1,4-benzenediamines.

Another class of photoalignment materials, which are typically polymers, can be used to form alignment layers. These polymers selectively react in the presence of polarized ultraviolet light along or perpendicular to the direction of the electric field vector of the polarized ultraviolet light, which once reacted, have been shown to align LC materials. Examples of these materials are described in U.S. Pat. Nos. 5,389,698, 5,602,661, and 5,838,407, all of which are incorporated herein by reference. Suitable photopolymerizable materials include polyvinyl cinnamate and other polymers such as those disclosed in U.S. Pat. Nos. 5,389,698, 5,602,661, and 5,838,407. Photoisomerizable compounds, such as azobenzene derivatives are also suitable for photoalignment, as described in U.S. Pat. Nos. 6,001,277 and 6,061,113, both of which are incorporated herein by reference.

Additionally, some lyotropic liquid crystal materials can also be used as alignment layers. Such materials, when shear-coated onto a substrate, strongly align thermotropic LC materials. Examples of suitable materials are described in, for example, U.S. Pat. No. 6,395,354, incorporated herein by reference.

As an alternative to alignment layers, the liquid crystal material of the polarization rotator can be aligned using an electric or magnetic field. Simply rubbing the substrate in a uniaxial direction is often sufficient to deposit an alignment layer and align liquid crystals, e.g., see Example 1. Yet another method of aligning the liquid crystal material is through shear or elongational flow fields, such as in a coating or extrusion process. The liquid crystal material may then be crosslinked or vitrified to maintain that alignment. Alternatively, coating the liquid crystal material on an aligned substrate, such as oriented polyesters like polyethylene terephthalate or polyethylene naphthalate, can also provide alignment.

A plasticizer can be added to the liquid crystal layer. While not wishing to be bound by any particular theory, it is believed that the plasticizer acts to provide better alignment between polymer domains. In an illustrative embodiment, plasticizer can be present in the liquid crystal layer from 0.1 to 5 phr, or 0.1 to 3 phr, or 1 to 2 phr.

The plasticizer can be chosen from among reactive monomer units or small molecules of similar structure to the monomers that form the liquid crystal layer. Single or multiple plasticizers can be employed to facilitate formation of the retarder coating. Thus for example, when an acrylate based liquid crystal is used to form the liquid crystal layer a particularly useful plasticizer is an acrylate molecule such as phenylalkyl (meth)acrylate (e.g., phenyl ethyl acrylate, phenyl ether acrylate, aryl ether acrylate, and the like.)

After coating, the liquid crystal material is converted into a liquid crystal layer. This conversion can be accomplished by a variety of techniques including evaporation of a solvent; heating; crosslinking the liquid crystal material; or curing (e.g., polymerizing) the liquid crystal material using, for example, heat, radiation (e.g., actinic radiation), light (e.g., ultraviolet, visible, or infrared light), an electron beam, or a combination of these or like techniques.

Optionally, initiators can be included within the liquid crystal material to initiate polymerization or crosslinking of monomeric components of the material. Examples of suitable initiators include those that can generate free radicals to initiate and propagate polymerization or crosslinking. Free radical generators can also be chosen according to stability or half-life. Preferably the free radical initiator does not generate any additional color in the liquid crystal layer by absorption or other means. Examples of suitable free radical initiators include thermal free radical initiators and photoinitiators. Thermal free radical initiators include, for example peroxides, persulfates, or azonitrile compounds. These free radical initiators generate free radicals upon thermal decomposition.

Photoinitiators can be activated by electromagnetic radiation or particle irradiation. Examples of suitable photoinitiators include, onium salt photoinitiators, organometallic photoinitiators, metal salt cationic photoinitiators, photodecomposable organosilanes, latent sulphonic acids, phosphine oxides, cyclohexyl phenyl ketones, amine substituted acetophenones, and benzophenones. Generally, ultraviolet (UV) irradiation is used to activate the photoinitiator, although other light sources can be used. Photoinitiators can be chosen based on the absorption of particular wavelengths of light.

A liquid crystal layer containing these initiators can be cured to “fix” the liquid crystal layer. Curing (e.g., polymerizing or cross-linking) the liquid crystal material can be accomplished using, for example, heat, radiation (e.g., actinic radiation), light (e.g., ultraviolet, visible, or infrared light), an electron beam, or a combination of these or like techniques.

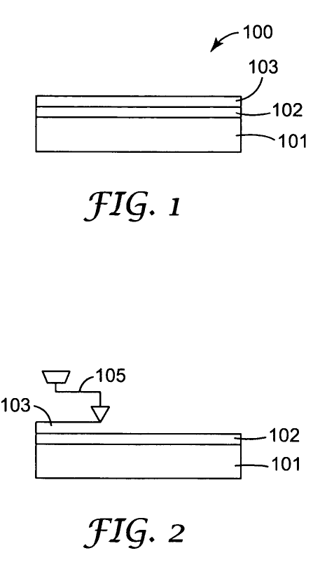

FIG. 1 is a sectional view of an optical body 100 according to an embodiment of the invention. The optical body 100 includes a substrate 101, an alignment layer 102 disposed on the substrate 101 and a liquid crystal layer 103 disposed on the alignment layer 102.

The liquid crystal layer 103 can function as an ideal or near ideal quarter wave plate. The liquid crystal layer 103 can have a retardation (R) at wavelengths (λ) from 400 nm to 700 nm equal to a formula R=λ/4±20 nm, or R=λ/4±15 nm, or R=λ/4±10 nm. The liquid crystal layer 103 can have a retardation (R) at wavelengths (λ) from 400 nm to 600 nm equal to a formula R=λ/4±20 nm, or R=λ/4±15 nm, or R=λ/4±10 nm.

The liquid crystal layer 103 can have a thickness in a range of 5 micrometers or less, 4 micrometers or less, 3 micrometers or less, 2 micrometers or less, or 1 micrometer or less. The liquid crystal layer 103 can have a thickness from 0.1 to 5 micrometers, or from 0.5 to 3 micrometers, from 1 to 3 micrometers, or from 1 to 2 micrometers, as desired.

The liquid crystal layer 103 can include 85 to 99 phr of an achiral liquid crystal material and 1 to 15 phr of a chiral nematic liquid crystal material. The liquid crystal layer 103 can include 90 to 99 phr of an achiral liquid crystal material and 1 to 10 phr of a chiral nematic liquid crystal material. The liquid crystal layer 103 can include 95 to 99 phr of an achiral liquid crystal material and 1 to 5 phr of a chiral nematic liquid crystal material.

The liquid crystal layer 103 further includes from 0.1 to 2 phr, or 0.5 to 1.5 phr of a surfactant. The liquid crystal layer 103 can further include from 0.1 to 5 phr, or 1 to 3 phr of a cross-linker. The liquid crystal layer 103 can further include from 0.1 to 5 phr, or 1 to 2 phr of a plasticizer.

FIG. 2 is a schematic view of a process for coating a retardation film onto a substrate according to an embodiment of the invention. An alignment layer 102 can be disposed on a substrate 101 as described above. A layer of flowable liquid crystal composition 103 is coated on the alignment layer 102. The liquid crystal composition can include a solvent. The layer of liquid crystal composition 103 can then be heated to remove solvent from the liquid crystal composition to form a liquid crystal composition layer. This liquid crystal composition layer can then be cured form a cross-linked liquid crystal layer, as desired. Curing (e.g., polymerizing or cross-linking) the liquid crystal material can be accomplished using, for example, heat, radiation (e.g., actinic radiation), light (e.g., ultraviolet, visible, or infrared light), an electron beam, or a combination of these or like techniques.

The liquid crystal retarder film can be used alone or in combination with other layers or devices to form an optical body, such as, for example, a reflective polarizer. The liquid crystal retarder films can be coated directly onto other optical bodies, eliminating the need for an additional adhesive layer or lamination process.

### EXAMPLES

Coated retarder films are formed according to the following procedure. Corning brand plain glass substrate 2947 was pre-cleaned with detergent and water and air blown dry. The substrate was mechanically rubbed with a natural cloth wipe to create an alignment surface or layer.

A liquid crystal mixture was formed according to the following formulation. LC242 (a mesogenic diacrylate from BASF) and LC 756 is a chiral mesogenic diacrylate from Merck. The solutions described below in Examples 1-2, 4 were coated on the rubbed glass with a #4 Mayer rod. The coated substrate was dried in a heated flow oven at 80 degree C. for four minutes to remove the solvent. This coated substrate was then subjected to a UV curing condition to crosslink diacrylate functional groups to form the liquid crystal polymer layer. The UV curing process was carried out with a Fusion UV system under an inert blanket of Nitrogen. The energy dose was at the level 2 J/cm². The cured film was not easily removed from the substrate by rubbing.

The retardation measurement was preformed with a Perkin Elmer Lamdba 900 UV-V is spectrophotometer (Wellesley, Mass. 02481-4078, USA) with a configuration of the coated sample between two polarizers. Retardation values at defined wavelengths can be calculated from the intensity measurements by a spectrophotometer using conventional equations. Knowing the film thickness of the retarder, birefringence can then be determined.

### Example 1

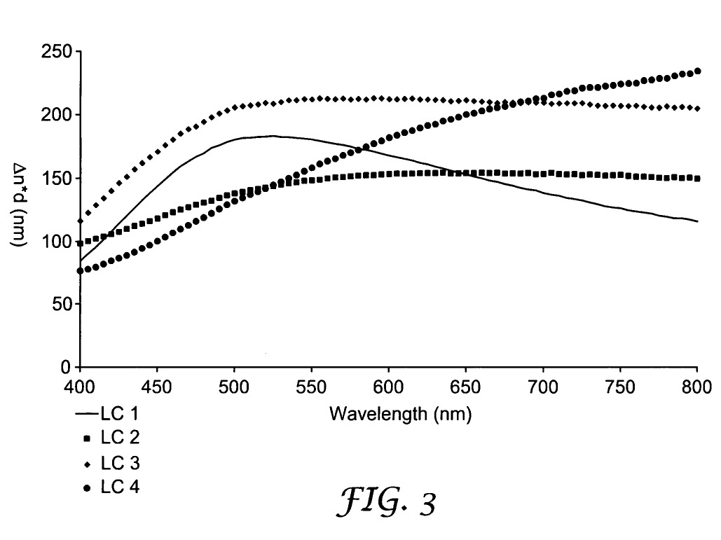

To 280 parts by weight of LC242 (an achiral nematic liquid crystal monomer from BASF) was added 10 parts by weight of a photinitator Igacure 819 from Ciba Specialty, Inc. and 1 part of fluorocompound FC-4430 from 3M, to form a solution in MEK at 30% solids. The solution was agitated and filtered through a 1 micron filter. This solution was coated with a #4 Mayer rod, dried and cured as described above. This example is shown in FIG. 3 as LC 1.

### Example 2

To the formulation of example 1 was added 5 parts by weight of LC 756 (a chiral nematic liquid crystal) from BASF to form a solution in MEK/dioxalane of ratio 85/15 with 30% solids. This solution was coated with a #4 Mayer rod, dried and cured as described above. The cured coating had a thickness of 2.7 micrometers. This example is shown in FIG. 3 as LC 2.

### Example 3

The solution from example 2 was coated with a Mayer rod #8, dried and cured as described in the previous examples. The cured coating had a thickness of 3.2 micrometers. This example is shown in FIG. 3 as LC 3.

### Example 4

To the formulation of example 3 was added phenyl ethyl acrylate (PEA) from Polyscience to form a solution in MEK/dioxalane of ratio 85/15 having 30% solids with PEA content of 1%. This solution was coated with a #4 Mayer rod, dried and cured as described above. This example is shown in FIG. 3 as LC 4.

The cured films of Examples 1-4 were measured with a PE900 UV-Vis spectrophotometer as described above to obtain the retardation values as shown in FIG. 3.

### Example 5

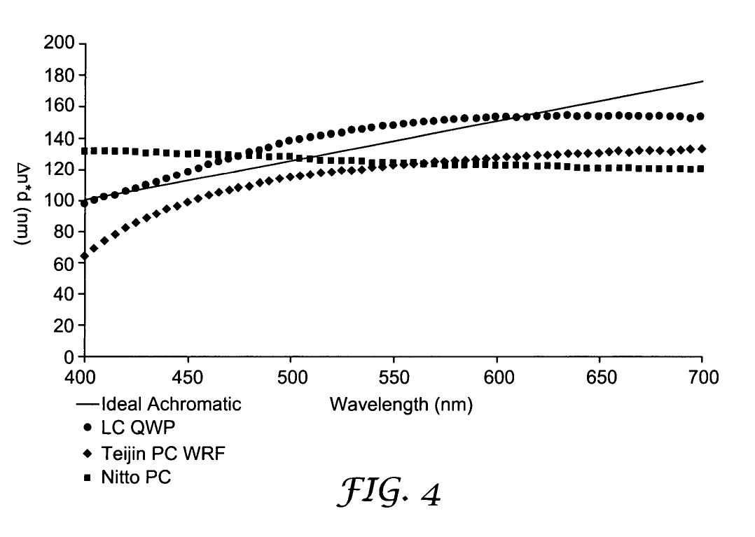

Comparative example polycarbonate retarder films (Tejin Ltd. and Nitto Denko Corp.) were tested as described above. Tejin WRF films are used as received. Nitto polycarbonate (PC) QWP was used as received. Both Teijin retarder and Nitto PC quarterwave retarders were measured in a same way as described above. A liquid crystal quarter wave plate (LC QWP) formed according to Example 2 was also measured. The results are shown in FIG. 4.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

1. An optical body comprising:
an optical element;
an alignment layer disposed on the optical element; and
a liquid crystal layer disposed on the alignment layer, the liquid crystal layer having a retardation (R) at all wavelengths (λ) from 400 nm to 700 nm equal to a formula R=λ/4±20 nm.

2. The optical body according to claim 1, wherein the liquid crystal layer has a retardation (R) at wavelengths (λ) from 400 nm to 700 nm equal to a formula R=λ/4±15 nm.

3. The optical body according to claim 1, wherein the liquid crystal layer has a retardation (R) at wavelengths (λ) from 400 nm to 700 nm equal to a formula R=λ/4±10 nm.

4. The optical body according to claim 1, wherein the liquid crystal layer has a thickness in a range of 5 micrometers or less.

5. The optical body according to claim 1, wherein the liquid crystal layer has a thickness in a range of 3 micrometers or less.

6. The optical body according to claim 1, wherein the optical element is a polarizer.

7. An optical body comprising:
an optical element;
an alignment layer disposed on the optical element; and
a liquid crystal layer coated on the alignment layer, the liquid crystal layer comprising:
85 to 99 phr of an achiral liquid crystal material;
1 to 15 phr of a chiral nematic liquid crystal material; and
a surfactant.

8. The optical body according to claim 7, wherein the liquid crystal layer comprises 95 to 99 phr of an achiral liquid crystal material, 1 to 5 phr of a chiral nematic liquid crystal material, and 0.1 to 2 phr of a fluorocarbon surfactant.

9. The optical body according to claim 7, wherein the liquid crystal layer comprises a polyacrylate.

10. The optical body according to claim 7, further comprising from 0.1 to 5 phr of a plasticizer.

11. The optical body according to claim 10, wherein the plasticizer comprises a reactive monomeric unit of the liquid crystal layer.

12. The optical body according to claim 10, wherein the plasticizer comprises an acrylate.

13. The optical body according to claim 10, wherein the plasticizer comprises a phenyl ethyl acrylate.

14. The optical body according to claim 7, wherein the surfactant comprises 0.1 to 5 phr of a fluorocarbon surfactant.

15. The optical body according to claim 14, wherein the surfactant comprises 0.1 to 5 phr of a perfluorocarbon surfactant.

16. The optical body according to claim 7, wherein the liquid crystal layer has a thickness in a range of 3 micrometers or less.

17. The optical body according to claim 7, wherein the liquid crystal layer has a thickness in a range of 1 micrometers or less.

18. The optical body according to claim 10, wherein the optical body is a polarizer.

19. A method of forming an optical body comprising the steps of:
applying an alignment layer of an optical element;
coating a flowable liquid crystal material on the alignment layer, the liquid crystal composition comprising:
85 to 99 phr of an achiral liquid crystal material;
1 to 15 phr of a chiral nematic liquid crystal material;
0.1 to 30 phr of a surfactant;
a solvent; and
removing the solvent from the liquid crystal material to form a liquid crystal layer.

20. The method according to claim 19, wherein the coating step comprises coating a flowable liquid crystal material on the alignment layer, wherein the liquid crystal material comprises 95 to 99 phr of an achiral liquid crystal composition, 1 to 5 phr of a chiral nematic liquid crystal composition, and 0.1 to 2 phr of a fluorocarbon surfactant.

21. The method according to claim 19, wherein the coating step comprises coating a flowable liquid crystal material on the alignment layer, the liquid crystal material further comprising from 0.1 to 5 phr of a plasticizer.

22. The method according to claim 19, wherein the applying step comprises applying an alignment layer on a polarizer.

23. The method according to claim 19, wherein the applying step comprises applying an alignment layer on a liquid crystal cell.

24. The method according to claim 19, further comprising the step of curing the liquid crystal layer.

25. The method according to claim 24, wherein the step of curing comprises curing the liquid crystal layer with U.V. light.

26. The method according to claim 19, wherein the coating step comprises coating a flowable liquid crystal material on the alignment layer, wherein the liquid crystal material comprises 95 to 99 phr of an achiral liquid crystal composition, 1 to 5 phr of a chiral nematic liquid crystal composition, and 0.1 to 5 phr of a fluorocarbon surfactant.

27. The method according to claim 19, wherein the coating step comprises coating a flowable liquid crystal material on the alignment layer, wherein the liquid crystal material comprises 95 to 99 phr of an achiral liquid crystal composition, 1 to 5 phr of a chiral nematic liquid crystal composition, and 0.1 to 5 phr of a perfluorocarbon surfactant.
